(19) United States
(12) Patent Application Publication
(10) Pub. No.: US 2022/0104479 A1
(43) Pub. Date: Apr. 7, 2022

(54) PORTABLE BLIND SYSTEM AND METHOD THEREOF

(71) Applicant: Daryn Yoder, Leon, IA (US)

(72) Inventor: Daryn Yoder, Leon, IA (US)

(21) Appl. No.: 17/549,781

(22) Filed: Dec. 13, 2021

Related U.S. Application Data
(63) Continuation-in-part of application No. 29/610,627, filed on Jul. 13, 2017, now Pat. No. D938310.

(51) Int. Cl. A01M 31/02; E04H 15/00; E04H 15/34

(52) U.S. Cl. CPC A01M 31/025; E04H 15/34; E04H 15/001

(57) ABSTRACT

A portable blind is provided. The blind includes a frame, wheel assembly, and hitch. The wheel assembly is configured to move between stowed and deployed configurations. In the deployed configuration, the wheels contact the ground and enable transport of the blind. In the stowed configuration, the wheels do not extend past the bottom of the frame of the blind, and thus the blind rests upon the ground. The hitch is also configured to move between stored and deployed configurations. In the deployed configuration, the hitch forms a “C” shape with its plurality of members, and in the stowed configuration the plurality of members are stacked on top of one another. A method of moving the wheel assembly and the hitch between their configurations is also provided.

### CROSS-REFERENCE TO RELATED APPLICATIONS

This application is a continuation-in-part application of co-pending U.S. Design patent application Ser. No. 29/610,627, filed Jul. 13, 2017, now U.S. Pat. No. D938310, the entire disclosure of which is incorporated herein by reference. The application is related to U.S. Design patent application Ser. No. 29/801,833, filed Jul. 31, 2021, the entire disclosure of which is incorporated herein by reference.

### FIELD OF THE INVENTION

The present invention relates generally to portable blinds. More specifically, the present invention is concerned with a portable blind with hitch assembly and support assemblies, the support assemblies movable between stowed and deployed configurations.

### BACKGROUND

Many hunters utilize non-permanent hunting structures known as blinds. These blinds are oftentimes single-room hut or tents which are camouflaged. The structure of these blinds include rods (typically made of fiberglass) or hubs which are designed to disassemble and/or collapse. Such disassemble is oftentimes time-consuming, frustrating, and results in fatigue on both the materials utilized for the blind as well as physical fatigue on the hunter themselves. As hunters often have multiple hunting spots, the disassembly and reassembly of the blind can serve as a significant obstacle to maximizing hunting efficiency.

Accordingly, it would be advantageous to provide a portable blind which does not require such assembly and disassembly. Further, it would be advantageous for such a blind to include a support assembly and a hitch assembly to enable the blind to towed either by hand or behind a vehicle. Additionally, it would be advantageous if the support assembly was configured to deploy and retract, in order to ensure the blind sat flush to the ground when in use.

### SUMMARY

The present invention comprises a portable blind system and method thereof. The portable blind includes a frame assembly, opposed support assemblies coupled to opposed sides of the frame assembly, and a hitch assembly extending from a front end of the frame assembly. The support assemblies, in some embodiments, are wheels. In some other embodiments, the support assemblies are skis. The frame assembly supports a fabric (such as a camouflage patterned fabric) material or other exterior covering for concealing an occupant within the portable blind. Each support assembly is moveable between a stowed configuration and a deployed configuration, thereby raising and lowering a bottom edge of the frame assembly relative to the ground. The support assembly is movable via a scissor-style lift, wherein members move towards and away from each other around or via a common hinge.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION

A preferred embodiment of the invention, illustrative of the best mode in which the applicant has contemplated applying the principles, is set forth in the following description and is shown in the drawings and is particularly and distinctly pointed out and set forth in the appended claims.

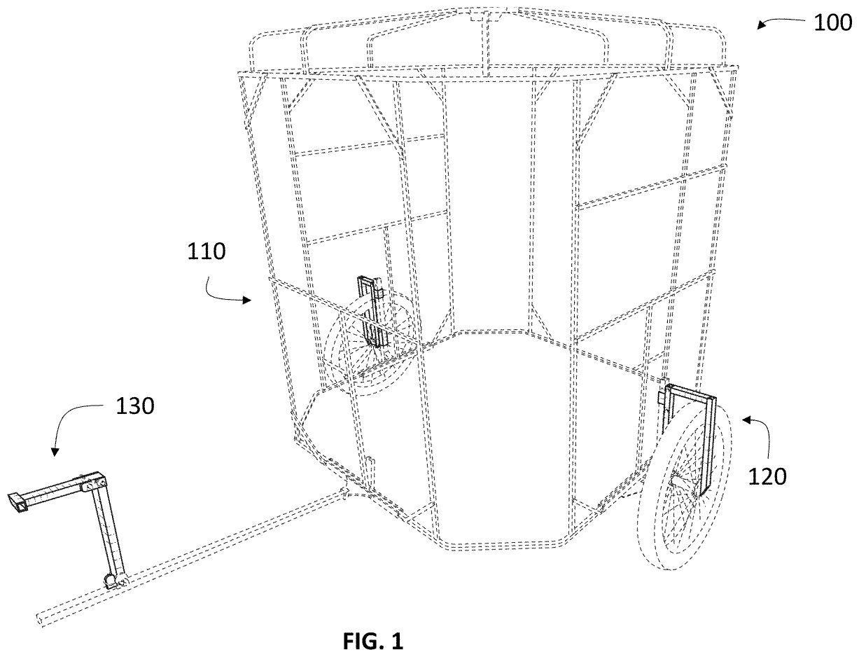

FIG. 1 is a perspective view of a first embodiment of a portable blind of the present invention, opposed wheel assemblies of the portable blind and a handle assembly of the portable blind being shown in respective deployed configurations.

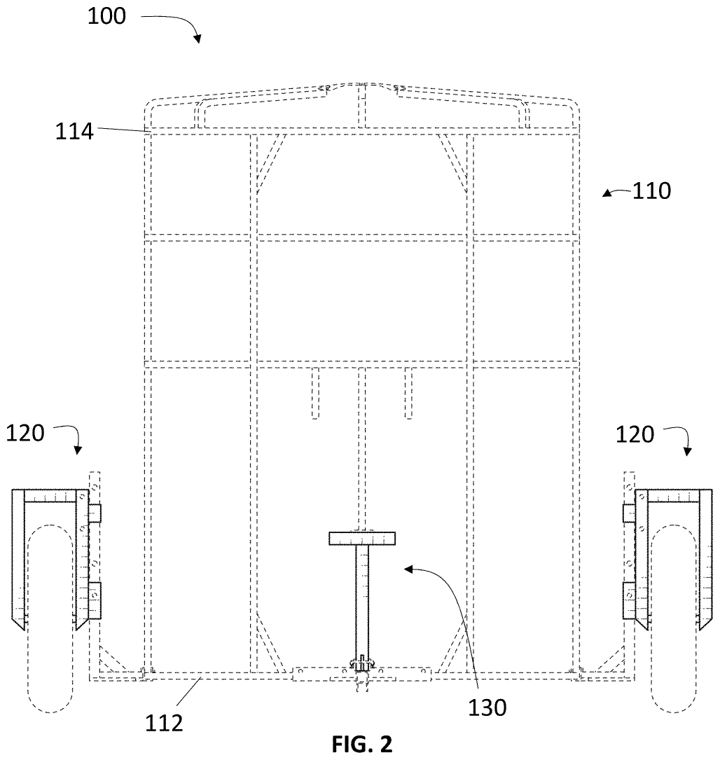

FIG. 2 is a front elevation view of the portable blind of FIG. 1.

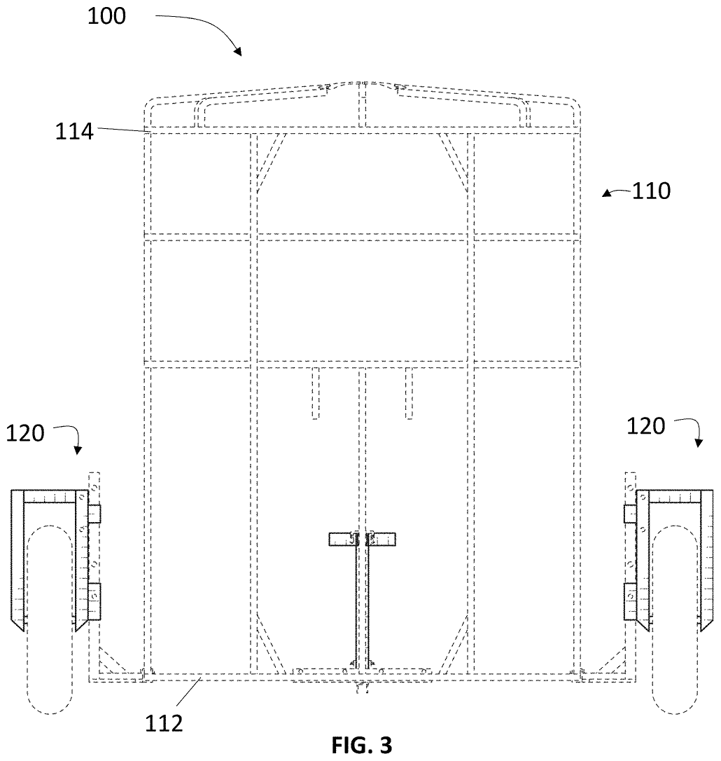

FIG. 3 is a rear elevation view of the portable blind of FIG. 1.

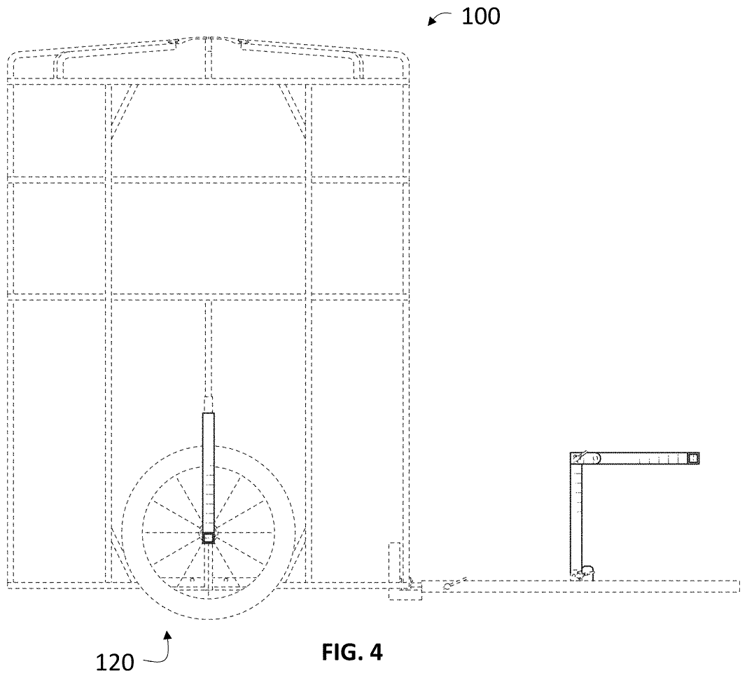

FIG. 4 is a side elevation view of the right side of the portable blind of FIG. 1.

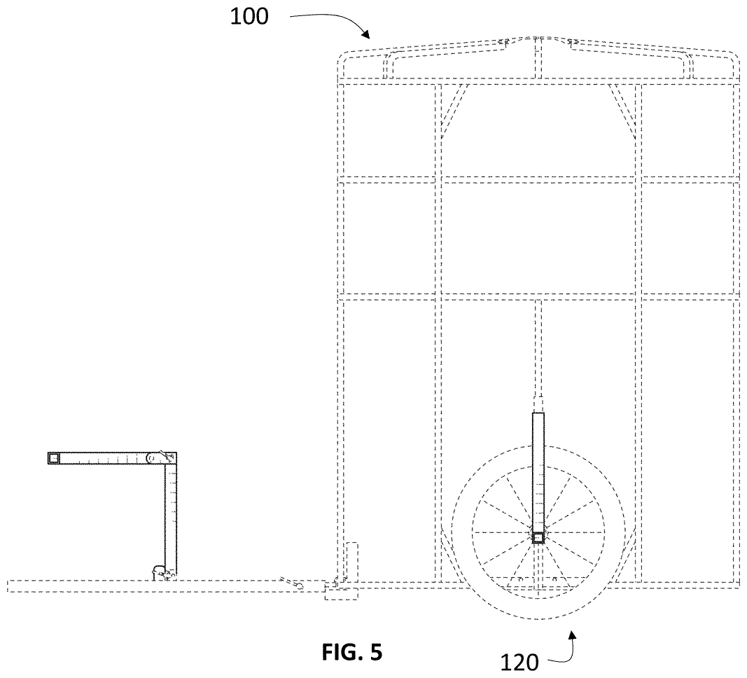

FIG. 5 is a side elevation view of the left side of the portable blind of FIG. 1.

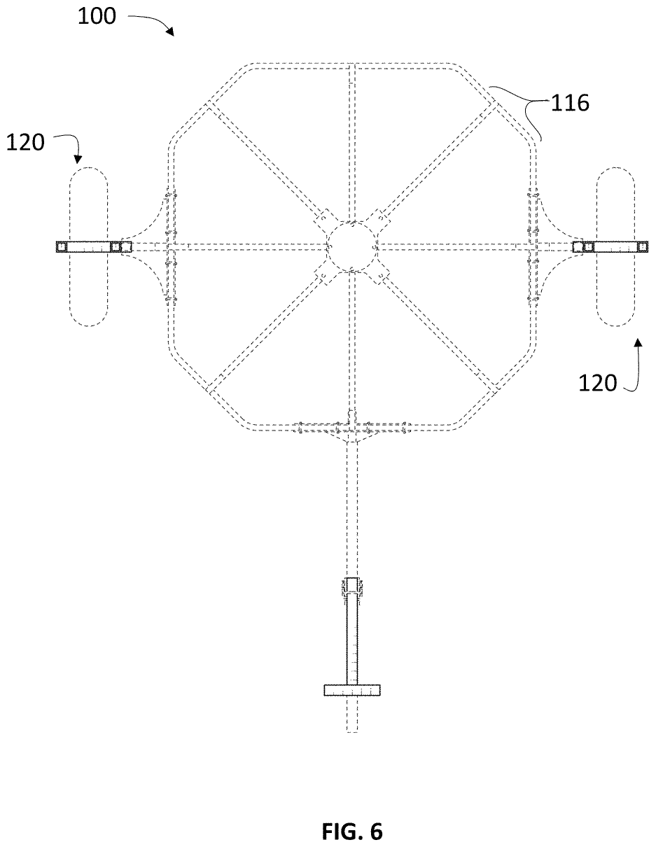

FIG. 6 is a top plan view of the portable blind of FIG. 1.

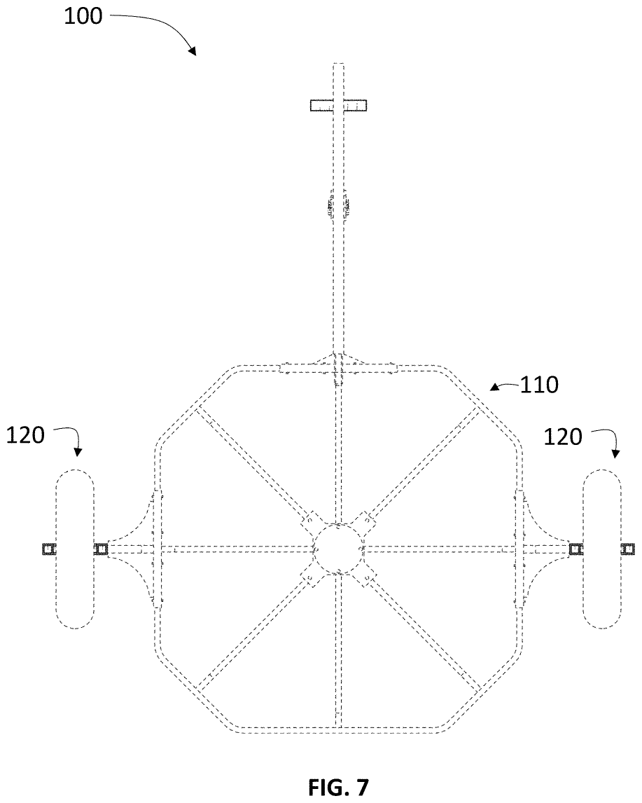

FIG. 7 is a bottom plan view of the portable blind of FIG. 1.

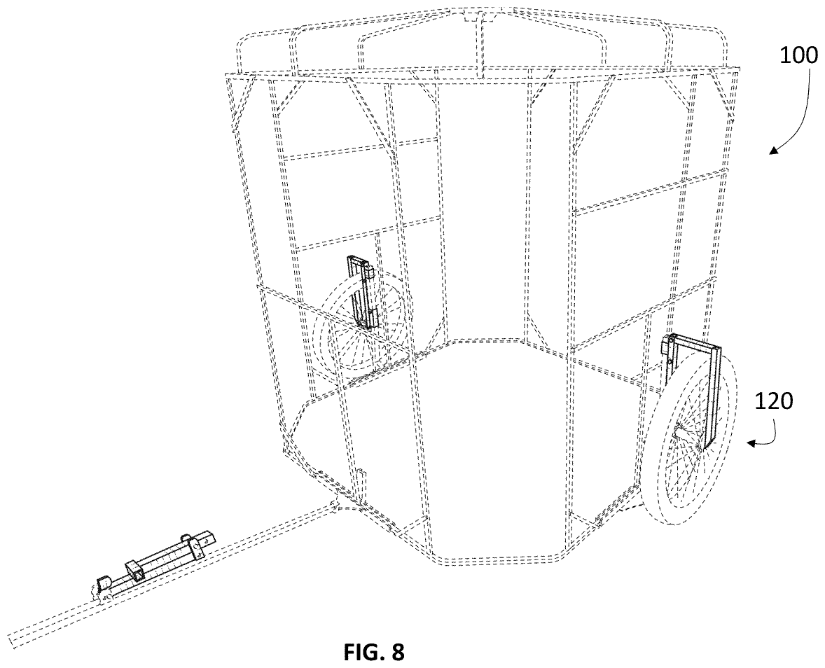

FIG. 8 is a perspective view of a first embodiment of a portable blind of the present invention, opposed wheel assemblies of the portable blind and a handle assembly of the portable blind being shown in respective stowed configurations.

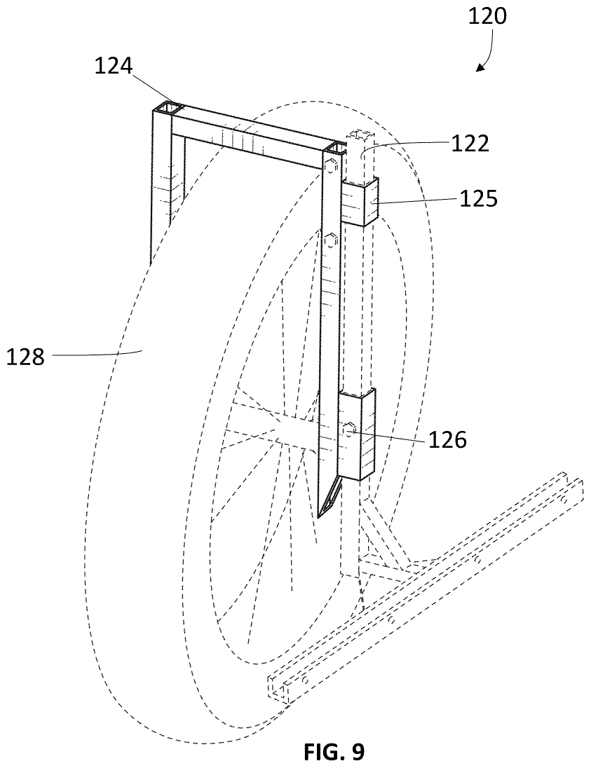

FIG. 9 is a perspective view of a first embodiment of a wheel assembly of the portable blind of the present invention, the wheel assembly being shown in a deployed configuration.

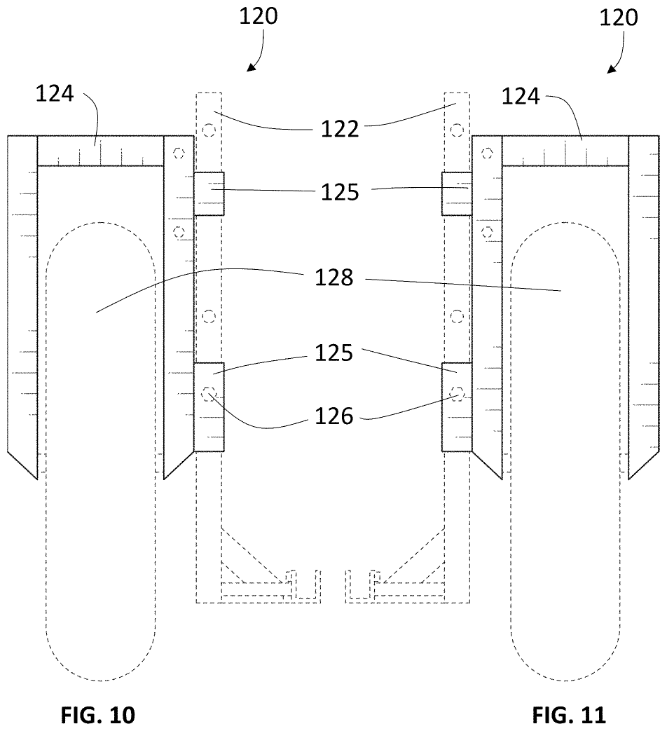

FIG. 10 is a front elevation view of the wheel assembly of FIG. 9.

FIG. 11 is a rear elevation view of the wheel assembly of FIG. 9.

FIG. 12 is a side elevation view of the right side of the wheel assembly of FIG. 9.

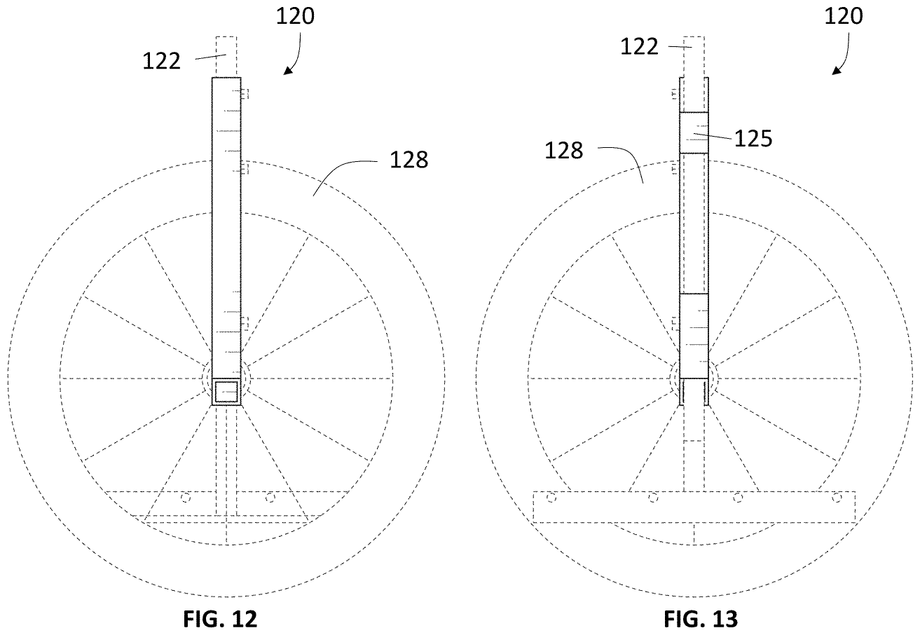

FIG. 13 is a side elevation view of the left side of the wheel assembly of FIG. 9.

FIG. 14 is a top plan view of the wheel assembly of FIG. 9.

FIG. 15 is a bottom plan view of the wheel assembly of FIG. 9.

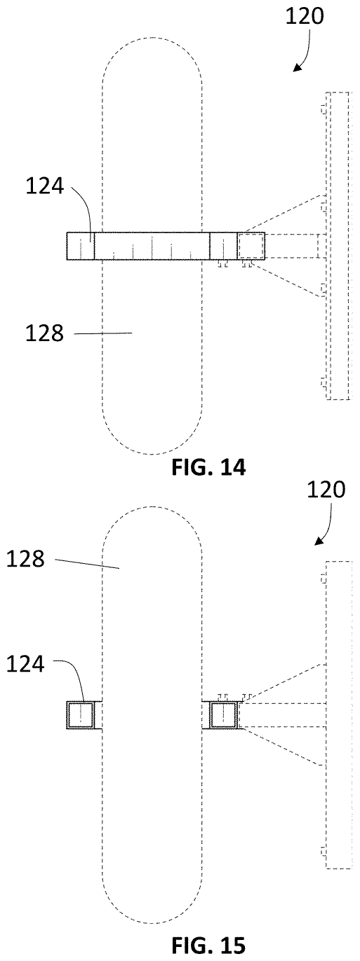

FIG. 16 is a perspective view of a first embodiment of a wheel assembly of the portable blind of the present invention, the wheel assembly being shown in a stowed configuration.

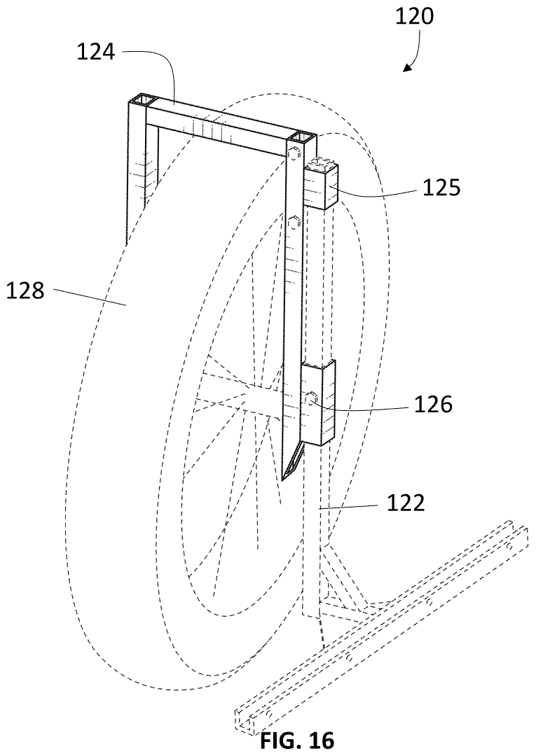

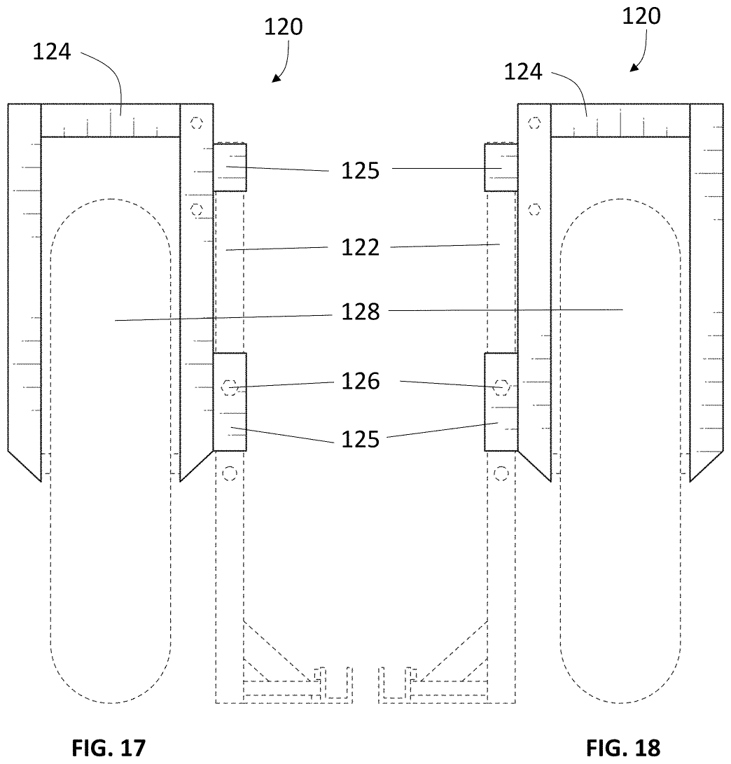

FIG. 17 is a front elevation view of the wheel assembly of FIG. 16.

FIG. 18 is a rear elevation view of the wheel assembly of FIG. 16.

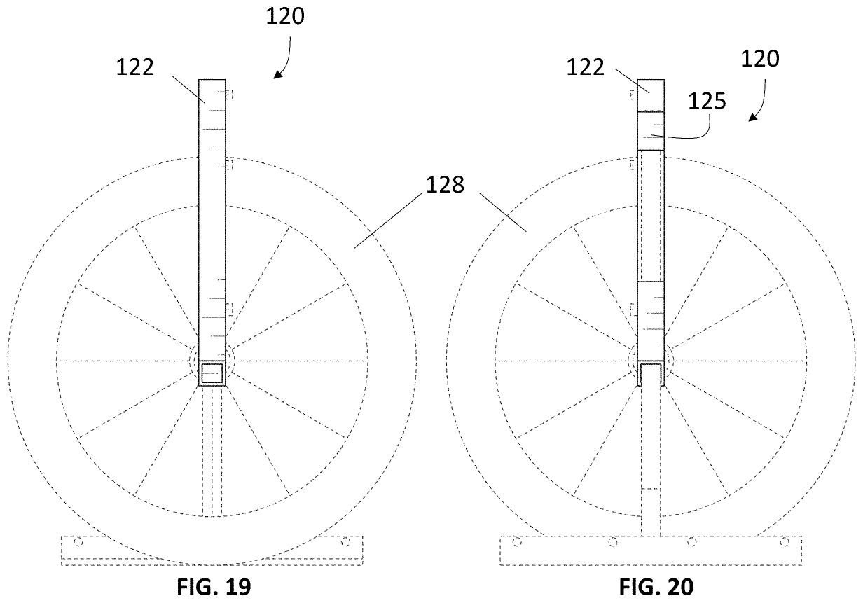

FIG. 19 is a side elevation view of the right side of the wheel assembly of FIG. 16.

FIG. 20 is a side elevation view of the left side of the wheel assembly of FIG. 16.

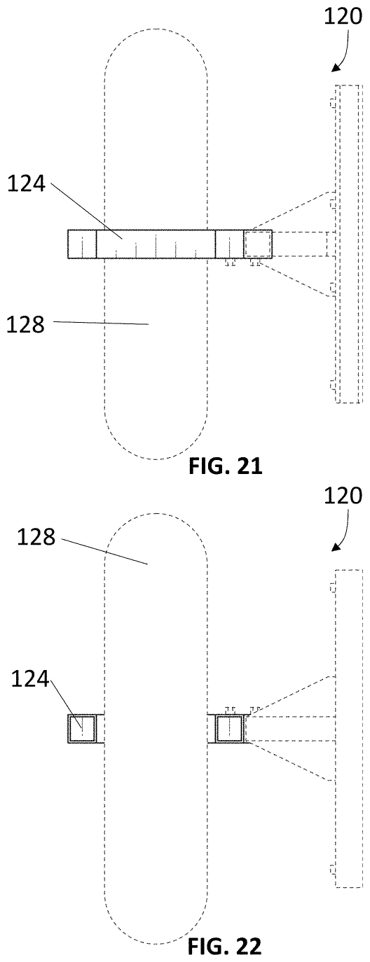

FIG. 21 is a top plan view of the wheel assembly of FIG. 16.

FIG. 22 is a bottom plan view of the wheel assembly of FIG. 16.

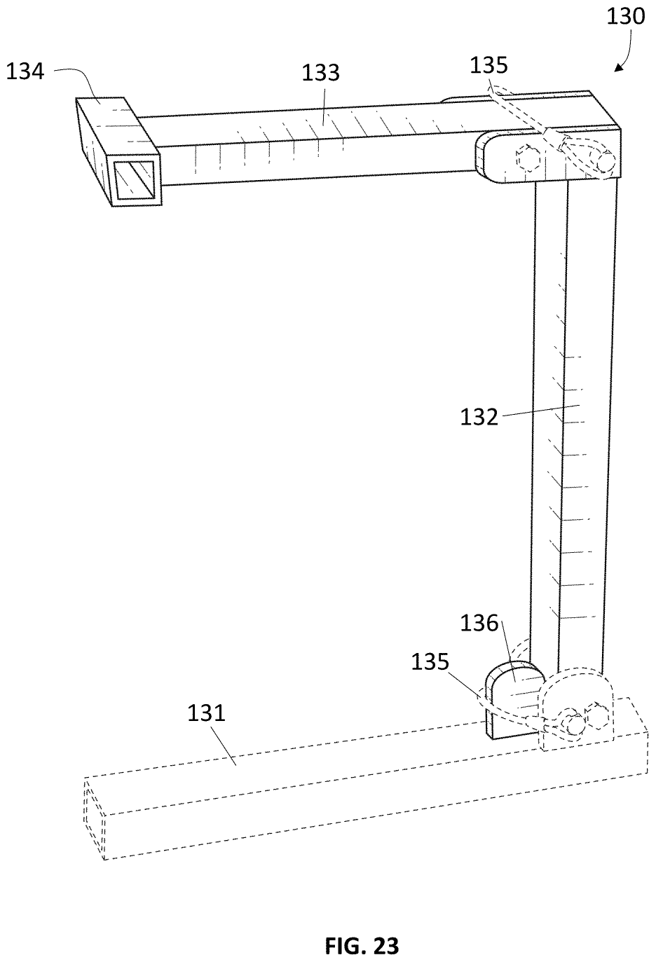

FIG. 23 is a perspective view of a first embodiment of a handle assembly of the portable blind of the present invention, the handle assembly being shown in a deployed configuration.

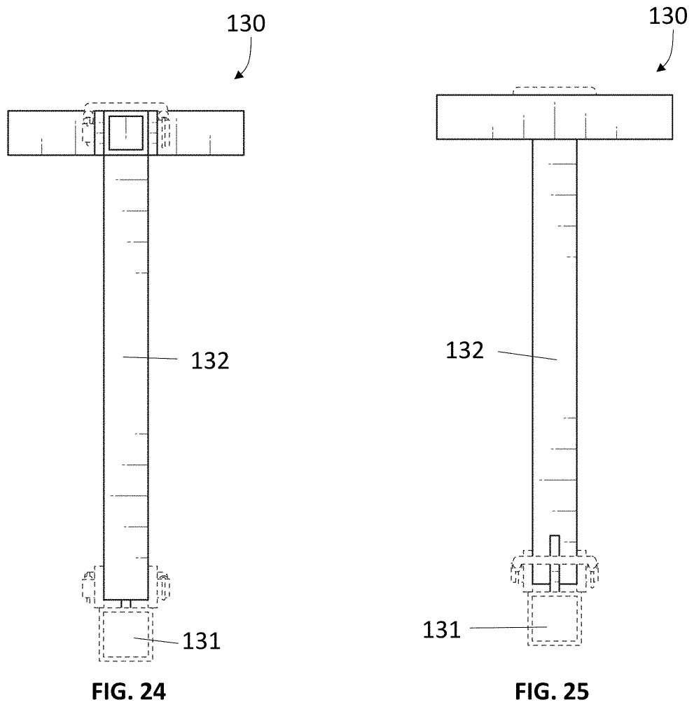

FIG. 24 is a rear elevation view of the handle assembly of FIG. 23.

FIG. 25 is a front elevation view of the handle assembly of FIG. 23.

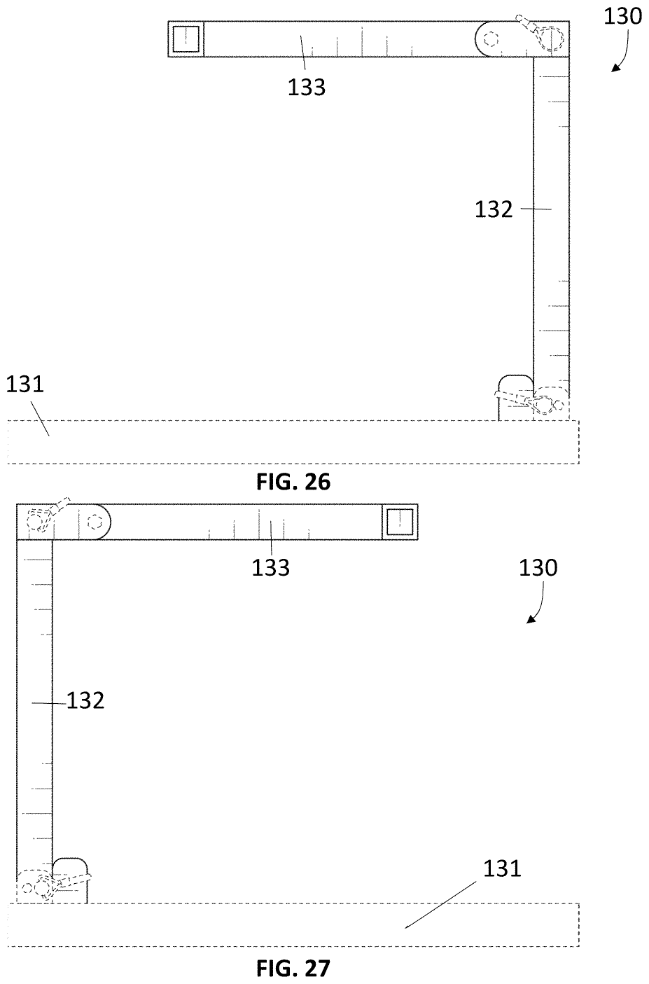

FIG. 26 is a side elevation view of the left side of the handle assembly of FIG. 23.

FIG. 27 is a side elevation view of the right side of the handle assembly of FIG. 23.

FIG. 28 is a top plan view of the handle assembly of FIG. 23.

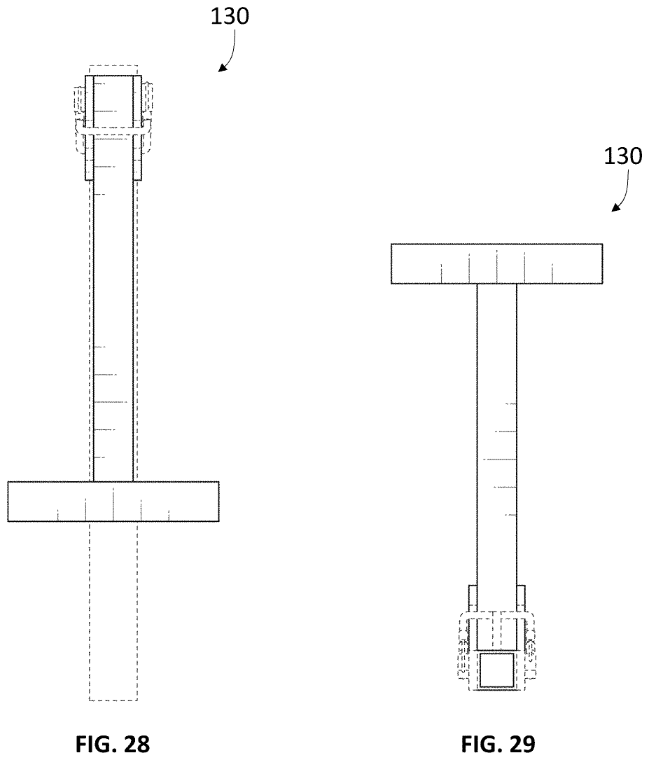

FIG. 29 is a bottom plan view of the handle assembly of FIG. 23, an elongated beam of the hitch assembly being removed for clarity.

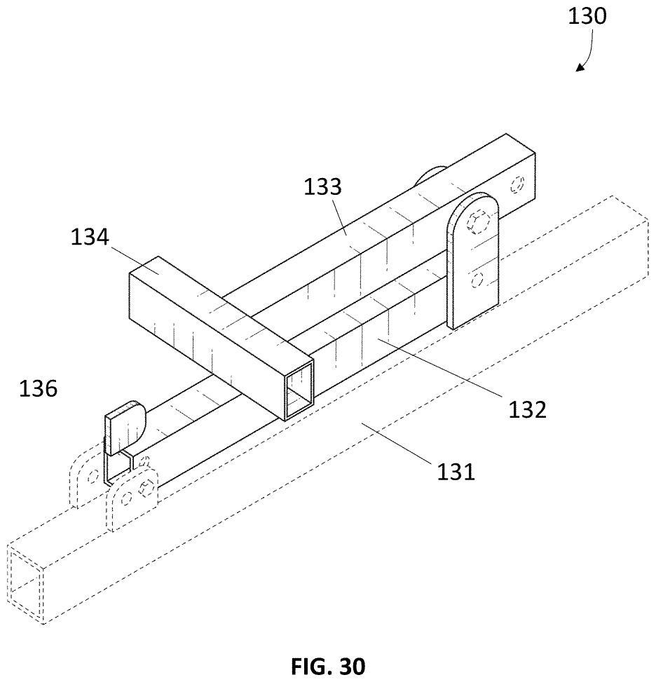

FIG. 30 is a perspective view of a first embodiment of a handle assembly of the portable blind of the present invention, the handle assembly being shown in a stowed configuration.

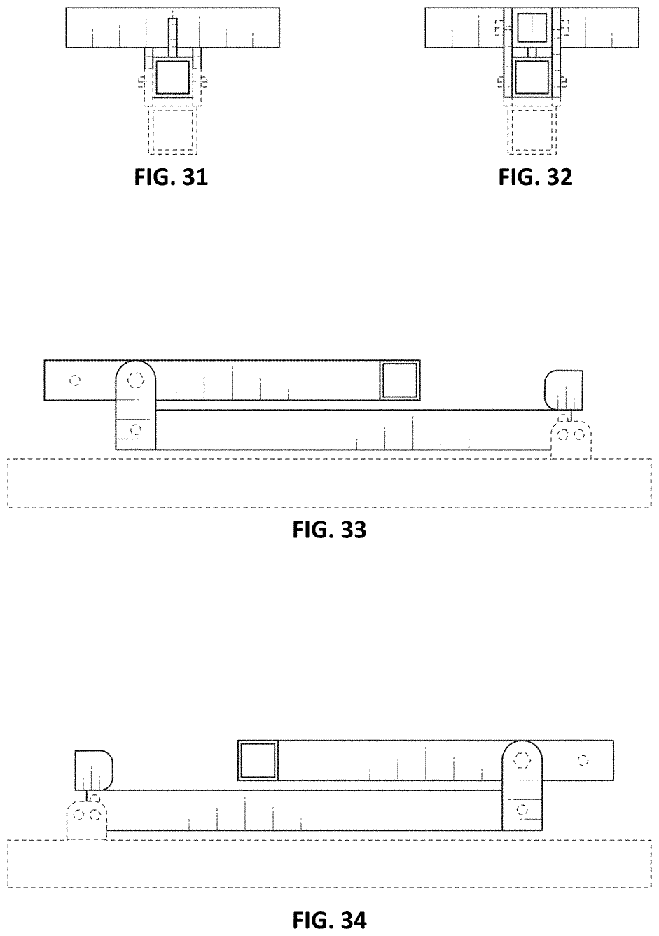

FIG. 31 is a rear elevation view of the handle assembly of FIG. 30.

FIG. 32 is a front elevation view of the handle assembly of FIG. 30.

FIG. 33 is a side elevation view of the left side of the handle assembly of FIG. 30.

FIG. 34 is a side elevation view of the right side of the handle assembly of FIG. 30.

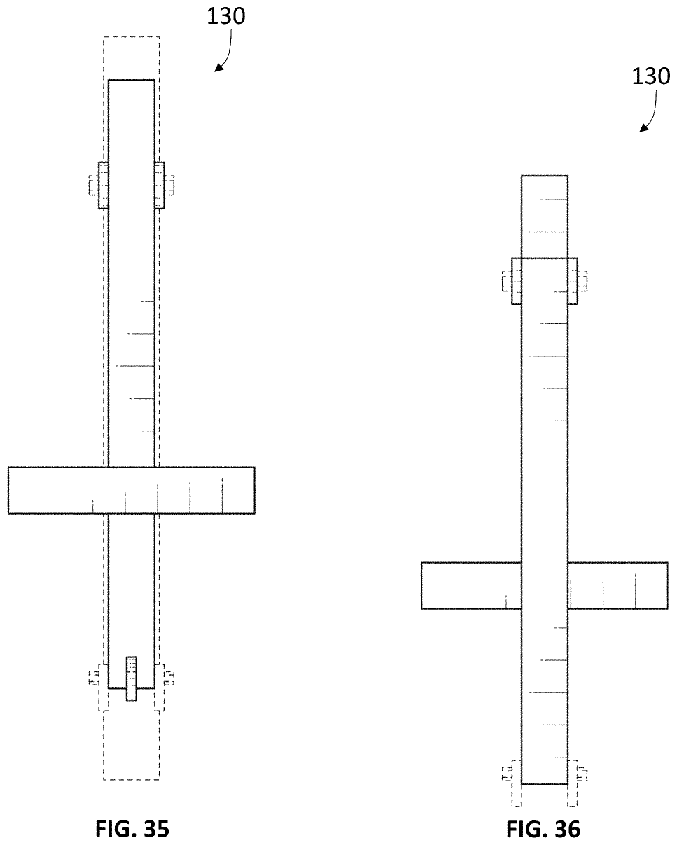

FIG. 35 is a top plan view of the handle assembly of FIG. 30.

FIG. 36 is a bottom plan view of the handle assembly of FIG. 30, an elongated beam of the hitch assembly being removed for clarity.

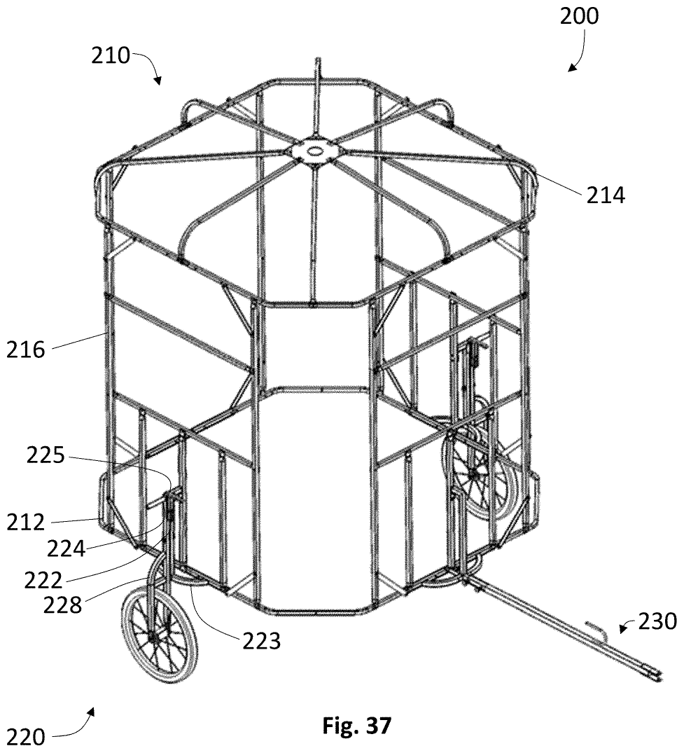

FIG. 37 is a perspective view of a blind according to some embodiments of the present invention.

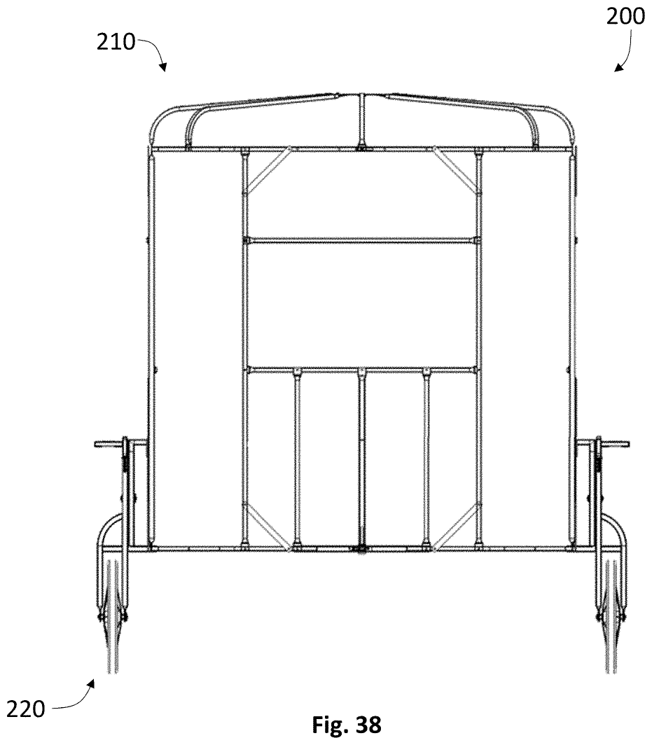

FIG. 38 is a front view of the blind of FIG. 37.

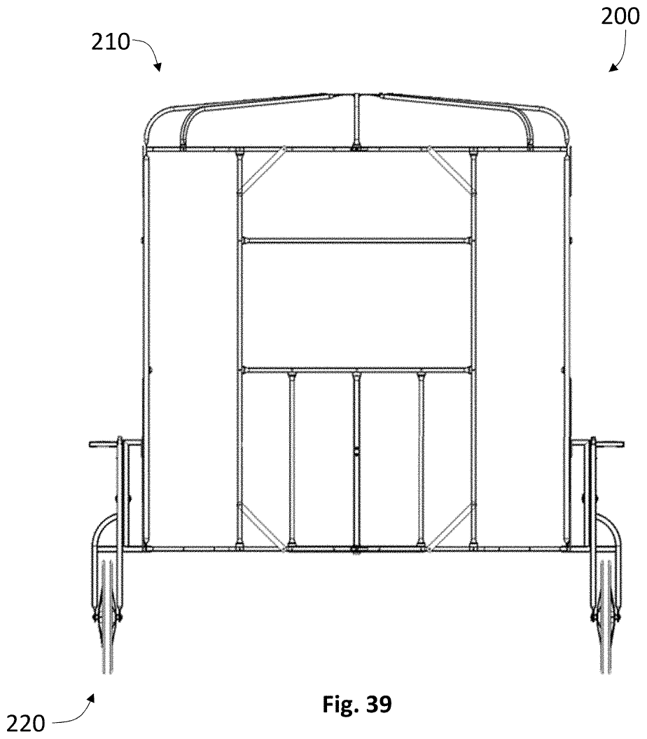

FIG. 39 is a rear view of the blind of FIG. 37.

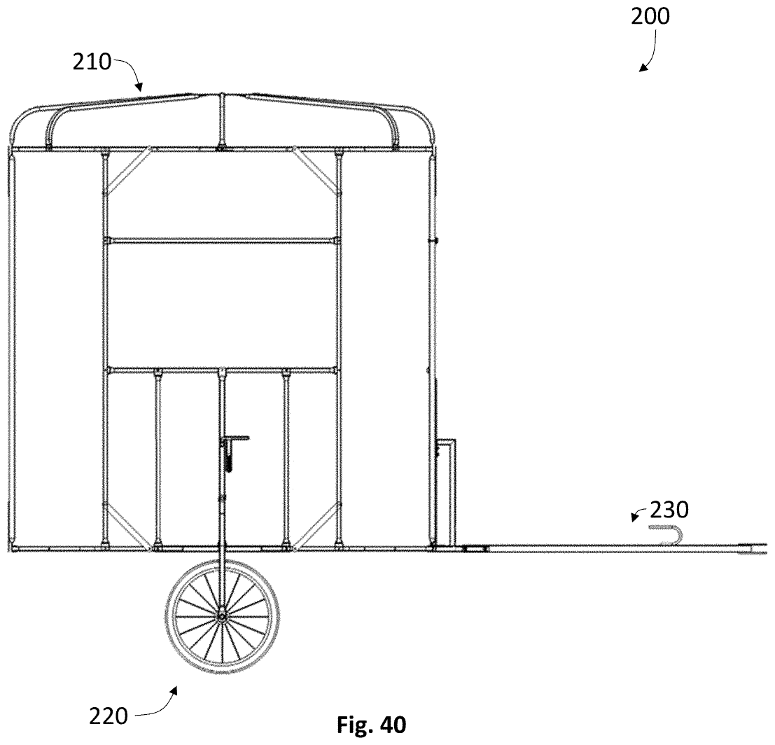

FIG. 40 is a left view of the blind of FIG. 37.

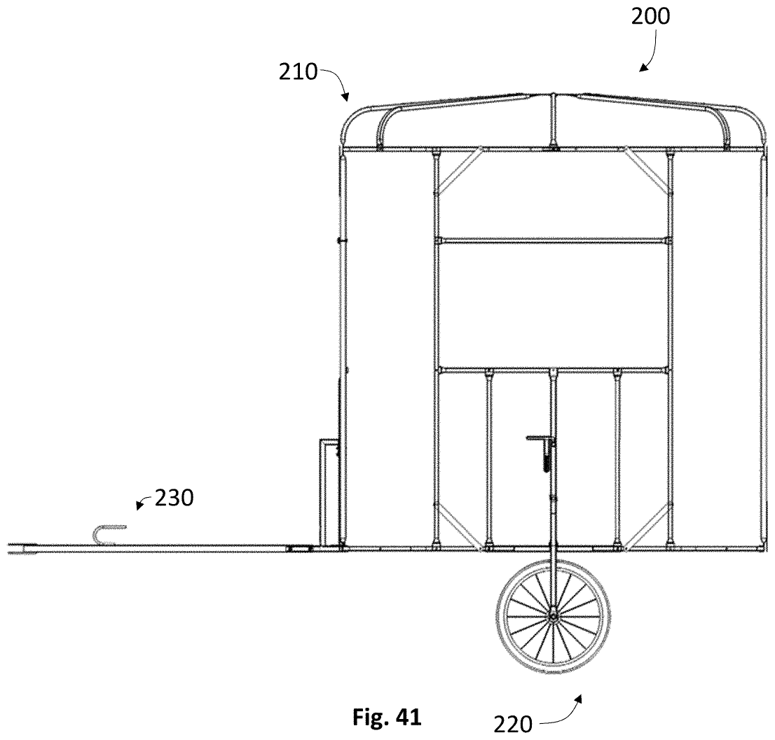

FIG. 41 is a right view of the blind of FIG. 37.

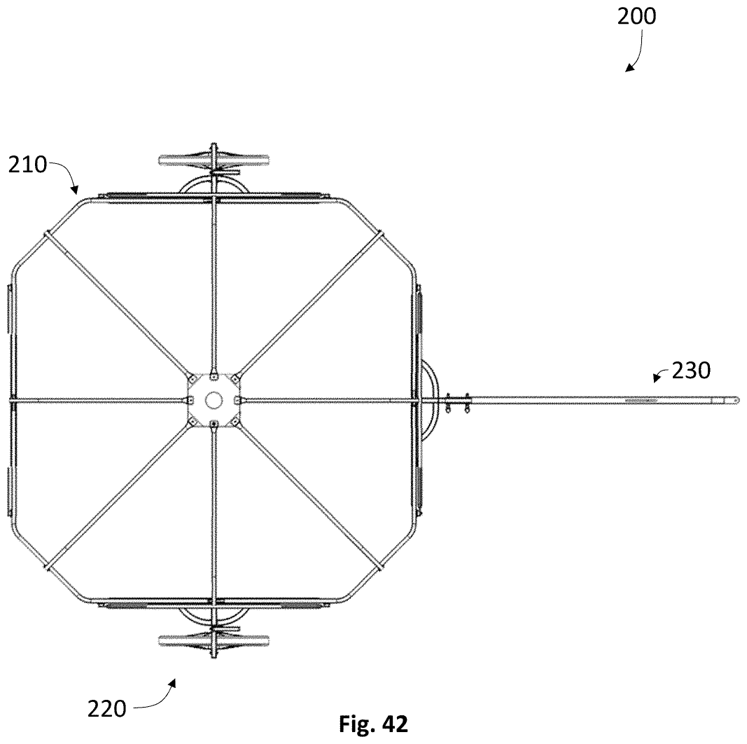

FIG. 42 is a top view of the blind of FIG. 37

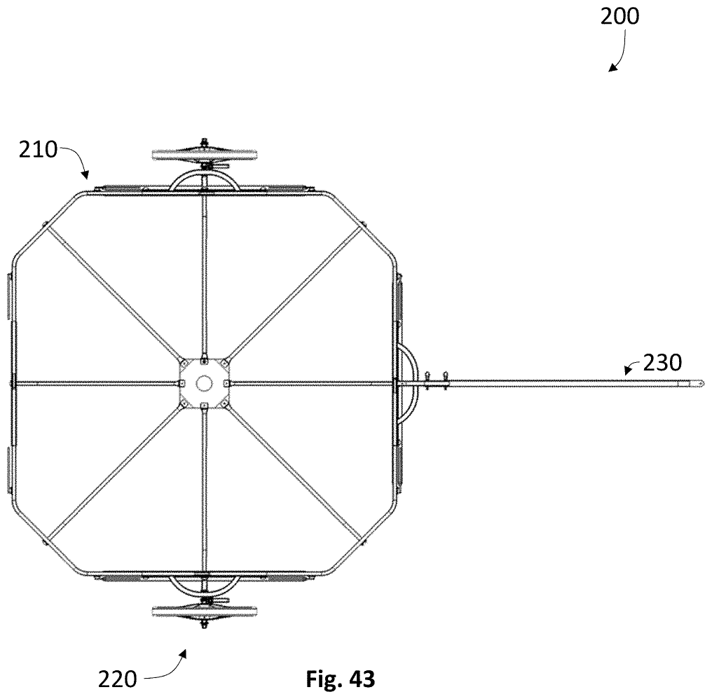

FIG. 43 is a bottom view of the blind of FIG. 37.

Exhibit A includes information relevant to the present disclosure.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to FIGS. 1-8, a portable blind 100 is considered. In some embodiments, the blind 100 is constructed of one or more structural members, such as metal rods (hollow or solid), C-frame bars, or the like. The structural members are sufficiently rigid to maintain the shape of the blind while in transport and while in use. In some embodiments, the structural members make up a bottom portion 112 of the blind, which in some embodiments is a perimetral frame with no intermediary elements. In some embodiments, the structural member make up a top portion 114 of the frame. The top portion 114 includes a perimetrical frame and, in some embodiment, structural elements which span across the middle section bounded by the perimetral frame. In some embodiments, the frame also includes a perimetrical wall 116 running between the bottom portion 112 and top portions 114 of the frame. In some embodiments, the perimetral wall 116 is circular, while in some embodiments it is square or rectangular. In some embodiments, the perimetrical wall 116 includes one or more opening sized large enough for a firearm to pass through. In some embodiments, the opening are large enough for a person to view, aim, and shoot a firearm through. In some embodiments, the blind further includes a cover (not depicted) with one or more openings. In some embodiments, the one or more openings of the cover substantially align with the openings of the perimeter wall. In some embodiments, the cover is camouflaged.

Referring to FIGS. 9-22, In some embodiments, the blind 100 includes one or more wheel assembly 120. In some embodiments, the blind includes two opposing wheel assemblies 120. In some embodiments, the wheel assembly 120 attaches to a bottom portion 112 of the frame. In some embodiments, where two opposing wheel assemblies are considered, the opposing wheel assemblies 120 attach to opposing bottom portions 112 of the frame. In some embodiments, the wheel assemblies 120 attach to a portion of the side wall.

In some embodiments, the wheel assembly includes a vertical stanchion member 122. In some embodiments, the vertical stanchion member 122 attaches to a bottom portion 112 and/or perimetral wall portion 116 of the frame. In some embodiments, the wheel assembly includes a wheel frame 124. In some embodiments, the wheel frame is generally “C” shaped. In some embodiments, the wheel frame includes one or more frame attachment point 125, which is configured to slidably engage with stanchion member 122. In some embodiments, The wheel frame 124 includes one or more stanchion securing element 126, which are configured to lock the wheel frame 124 in place relative to the stanchion member 122. In some embodiments, such securing element 126 is a screw, bolt, or other selectively securing means.

In some embodiments, the wheel assembly 120 further includes a wheel 128 affixed to the wheel frame 124. In some embodiments, the wheel 128 is affixed to the open gap of the “C” shape of the wheel frame 124, such that the “C” portion of the wheel frame 124 bounds the upper portion of the wheel 128. In some embodiments, the wheel is affixed such that it rotates freely when a force is applied to the wheel.

In some embodiments, the wheel assembly is movable between stowed and deployed configurations. In the stowed configuration, the wheel assembly is positioned such that the topmost frame attachment point 125 is proximate a top end of stanchion 122. In this position, the bottom of wheel 128 is positioned even with or higher than the lowermost portion of the bottom portion of the frame, such that the wheel is not contacting the ground when the blind is resting on the ground. In the deployed configuration, the lowermost frame attachment point 125 is proximate a bottom end of stanchion 122. In this position, the bottom of wheel 128 is positioned below the lowermost portion of the bottom portion of the frame, such that the wheel does contact the ground when the blind is at rest, thereby enabling the wheels to be utilized as the blind is moved from location to location.

Moving the wheel assembly between the stowed and deployed configurations includes, in some embodiments, one or more steps. In some embodiments, each of the stanchion securing elements 126 are disengaged from the stanchion. In some embodiments, the attachment points 125 are then slid or moved downward relative to the stanchion until the bottommost stanchion securing element 126 is proximate a bottom portion of the stanchion. In some embodiments, the securing elements are then engaged with the stanchion, thereby locking the wheel assembly into place. The process is performed in reverse to move from deployed to stowed configuration.

Referring to FIGS. 23-36, in some embodiments, the blind includes a hitch assembly 130. In some embodiments, the hitch assembly is movable between stowed and deployed configurations. In some embodiments, the hitch assembly includes one or more structural members. In some embodiments, the hitch assembly includes a first 131, second 132, and third 133 structural members. In some embodiments, the first structural member 131 includes an attachment end and a blind end, the second structural member includes a first end and a second end, and the third structural member includes a hitch end and a second end. In some embodiments, the hitch assembly 130 further includes one or more securing band 135 and one or more securing tab 136. The securing band 135, in some embodiments, is associated with one or more bolt or other securing element which is configured to lock or otherwise secure the aforementioned structural members in one or more configuration. In some embodiments, the securing tab 136 provides tensile force within the securing band 135 to further enhance the locking power of the securing band.

In some embodiments, the hitch assembly is configured to present in a deployed configuration. In some embodiments, in the deployed configuration, the first end of the second member is rotationally coupled with the attachment end of the first structural member. In some embodiments, the first member is positioned substantially horizontal, while the second member is positioned substantially vertical. In some embodiments, the second end of the second member is rotationally coupled with a second end of the third structural member. In some embodiments, the third structural member is positioned substantially horizontal. Referring to FIGS. 26 and 27, the resulting shape in the deployed configuration resembles a “C”. In some embodiments, the member retain these positions relative to one another due to the locking associated with securing bands 135 and securing tab 136. In some embodiments, the hitch further includes a fourth structural member 134, which attached to the hitch end of the third structural member at approximately a midpoint of the fourth structural member. In some embodiments, the fourth structural member serves as a hitch or other attachment point and is configured to facilitate pulling of the blind.

In some embodiments, the hitch assembly is movable between the deployed configuration and a stowed configuration. In some embodiments, the securing bands are disconnected from the assembly. In some embodiments, the second member rotates around a rotational connection point to the first member until the second member is resting substantially flush and parallel to the first member. In some embodiments, the third member moves about a rotation connection point to second member until third member is resting substantially flush and parallel to the second member, resulting in a stack of first, second, and third members. This resulting configuration, in some embodiments, is the stowed configuration.

Referring to FIGS. 37-43, one embodiment of a blind 200 is shown. In some embodiments, the blind includes a frame similar to the frame discussed above. In some embodiments, the blind 200 is constructed of one or more structural members, such as metal rods (hollow or solid), C-frame bars, or the like. The structural members are sufficiently rigid to maintain the shape of the blind while in transport and while in use. In some embodiments, the structural members make up a bottom portion 212 of the blind, which in some embodiments is a perimetral frame with no intermediary elements. In some embodiments, the structural member make up a top portion 214 of the frame. The top portion 214 includes a perimetrical frame and, in some embodiment, structural elements which span across the middle section bounded by the perimetral frame. In some embodiments, the frame also includes a perimetrical wall 216 running between the bottom portion 212 and top portions 214 of the frame. In some embodiments, the perimetral wall 216 is circular, while in some embodiments it is square or rectangular. In some embodiments, the perimetrical wall 216 includes one or more opening sized large enough for a firearm to pass through. In some embodiments, the opening are large enough for a person to view, aim, and shoot a firearm through. In some embodiments, the blind further includes a cover (not depicted) with one or more openings. In some embodiments, the one or more openings of the cover substantially align with the openings of the perimeter wall. In some embodiments, the cover is camouflaged.

In some embodiments, the blind 200 includes one or more wheel assembly 220. In some embodiments, the blind includes two opposing wheel assemblies 220. In some embodiments, the wheel assembly 220 attaches to a bottom portion 212 of the frame. In some embodiments, where two opposing wheel assemblies are considered, the opposing wheel assemblies 220 attach to opposing bottom portions 212 of the frame. In some embodiments, the wheel assemblies 220 attach to a portion of the side wall.

In some embodiments, the wheel assembly 220 includes a rotational stanchion 222. In some embodiments, a first portion of the stanchion 222 is connected to a securing member 223 associated with the bottom portion 212 of the frame. In some embodiments, the first portion of the stanchion 222 is a bottom portion of the stanchion 222. In some embodiments, a second portion of the stanchion 222 is connected via a securing element 224 to a receiving structure 225 associated with or otherwise attached to the frame. In some embodiments, the securing element 224 is configured to selectively disengage from the receiving structure 225, thus resulting in the connection with securing member 223 to be the only connection point when securing element 224 is disengaged. In some embodiments, the connection with securing member 223 is a rotational connection, in that the stanchion 222 can rotate freely about this connection point.

In some embodiments, the wheel assembly 220 includes includes a wheel frame 228. In some embodiments. In some embodiments, the wheel frame is substantially similar to the previous described wheel frame. In some embodiments, the wheel frame is connected to the stanchion in a fixed position, such that the wheel frame 228 moves relative to the movement of the stanchion 222.

In some embodiments, the wheel assembly 220 is configurable in a deployed configuration. In some embodiments, in the deployed configuration, the stanchion is oriented such that its longest dimensional length is substantially vertically aligned with the frame. In some embodiments, the stanchion is secured to the receiving structure, which locks the stanchion in an upright orientation. In this orientation, the bottom of the wheel is positioned below the bottommost portion of the frame. In some embodiments, the center of the wheel is generally aligned with the center of balance of the blind.

In some embodiments, the wheel assembly 220 is configurable in a stowed configuration. In some embodiments, in the stowed configuration, the stanchion is unsecured from the receiving structure. In some embodiments, the stanchion is oriented such that its longest dimensional length is substantially horizontally aligned. In this orientation, the lowest portion of the wheel relative to the frame is even with the bottom of the frame or above the frame, such that the wheel does not contact the ground. In some embodiments, the wheel is positioned such that it is off-center from the center of balance of the blind.

In some embodiments, moving the wheel assembly 220 between deployed and stowed configurations is contemplated. In some embodiments, the securing element is disengaged from the receiving structure. In some embodiments, force is then applied or the stanchion is otherwise rotated, such that center of balance moves away from the in-line center of rotation for the stanchion and the wheel assembly. In some embodiments, the stanchion is continued to be rotated, either by force applied to the stanchion or the falling of the blind due to the inbalance combined with gravitational forces. In some embodiments, the rotation of the stanchion causes the wheel to be rotated away from the center of balance and upwards relative to the frame of the blind. This rotation continues until the frame contacts the ground. To move from stowed to deployed configurations, the frame is raised from the ground and the wheel assembly is rotated back in-line with the center of balance of the frame. In some embodiments, the stanchion is engaged with the receiving structure, thereby locking it in an upright orientation.

In some embodiments, the blind 220 includes a hitch assembly. In some embodiments, the hitch assembly 230 is substantially similar to the one previously described. In some embodiments, the hitch assembly includes an extension member and a hooking member. In some embodiments, the hooking member includes one or more securing connection elements, such that the hook is configured to engaged with one or more hitch of a vehicle or the like. In some embodiments, the end of the extension member includes one or more securing connection elements, such that the extension member is configured to engaged with one or more hitch of a vehicle or the like

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A portable blind comprising:
a frame, said frame including a bottom portion, a top portion, and a perimeter wall, and opposing wheel assemblies attached to opposing sides of said bottom portion,
wherein the wheel assemblies are configured to move between stowed and deployed configurations.

2. The portable blind of claim 1, wherein each wheel assembly comprises:
a vertical stanchion member;
a wheel frame slidably attached to said vertical stanchion member; and
a wheel affixed to said wheel frame.

3. The portable blind of claim 2, wherein the wheel of the wheel assembly is positioned above a surface when the blind is resting on said surface, when the wheel assembly is in the stowed configuration.

4. The portable blind of claim 3, wherein the wheel of the wheel assembly is positioned in contact with the surface and bearing at least a portion of the weight of the blind when the wheel assembly is in the deployed configuration.

5. The portable blind of claim 2, wherein the wheel assembly is connected a securing element associated with the bottom portion of the frame at a first portion of the stanchion.

6. The portable blind of claim 5, wherein the wheel assembly is further selectively connected to a receiving structure associated with the frame at a second portion of the stanchion, when the wheel assembly is in the deployed configuration.

7. The portable blind of claim 5, wherein moving the wheel assembly between deployed and stowed configurations includes:
disconnecting the second portion of the stanchion from the receiving structure;
applying a force to the portable blind from a first direction; and
rotating said stanchion about the connection at the first point of the stanchion until the frame contacts a surface.

8. The portable blind of claim 1, wherein a wheel of the wheel assembly is positioned above a surface when the blind is resting on said surface, when the wheel assembly is in the stowed configuration.

9. The portable blind of claim 5, wherein a wheel of the wheel assembly is positioned in contact with the surface and bearing at least a portion of the weight of the blind when the wheel assembly is in the deployed configuration.

10. A wheel assembly for a portable blind comprising:
a vertical stanchion member;
a wheel frame slidably attached to said vertical stanchion member; and
a wheel affixed to said wheel frame

11. The wheel assembly of claim 10 wherein the wheel assembly is configured to move between stowed and deployed configurations.

12. The wheel assembly of claim 11, wherein the a first portion of the stanchion is configured to rotate about a connection point when connected to a portable blind.

13. The wheel assembly of claim 12, wherein a second portion of the stanchion includes a securing element, said securing element configured to selectively engage with a receiving structure of the portable blind.

14. The wheel assembly of claim 13, wherein the assembly is locked into the deployed configuration when the securing element is engaged with the receiving structure of the portable blind.

15. The wheel assembly of claim 13, wherein moving the wheel assembly between deployed and stowed configurations includes:
disconnecting the securing element from the receiving structure;
applying a force to the wheel assembly from a first direction; and
rotating said stanchion about the connection at the first point of the stanchion.

16. A method of moving a wheel assembly between deployed and stowed configurations, the method comprising the steps:
disconnecting a securing element from a receiving structure;
applying a force to a wheel assembly from a first direction; and
rotating a stanchion of the wheel assembly about a connection at the first point of the stanchion.

17. The method of claim 16, wherein said rotation moves said wheel of said wheel assembly away from a center of balance of structure attached to the wheel assembly.

18. The method of claim 17, wherein that structure is a portable blind.
